(19) United States
(12) Patent Application Publication
(10) Pub. No.: US 2011/0266335 A1
(43) Pub. Date: Nov. 3, 2011

(54) GIFT WRAP ASSEMBLY AND METHOD OF MAKING THE SAME

(76) Inventor: Michael J. Glowacki, Jamaica Plain, MA (US)

(21) Appl. No.: 12/772,183

(22) Filed: May 1, 2010

(51) Int. Cl. B65D 5/00; B31B 3/00

(52) U.S. Cl. 229/103.2; 493/162

(57) ABSTRACT

A gift wrap assembly for adorning a beverage case includes a box for at least partially covering the beverage case. The box includes a top wall, four sidewalls, and a bottom opening. The gift wrap assembly further includes at least one gripping feature configured on at least one of the top wall and two oppositely configured sidewalls of the four sidewalls. Each gripping feature of the at least one gripping feature is being conformed to substantially match a gripping feature in a corresponding wall of the beverage case. Further disclosed is an unfolded gift wrap assembly for adorning the beverage case. Also disclosed is a method of making the gift wrap assembly.

### FIELD

The present disclosure generally relates to gift wrap assemblies, and more particularly, to a gift wrap assembly for adorning a beverage case.

### BACKGROUND

In the liquor industry, various types of gift wrap assemblies have been used for housing cases of beverages including beer. Specifically, gift wrap assemblies have been used for packaging and adorning beverage cases that may hold bottles or cans of beverages in various volumes.

However, most of the currently available gift wrap assemblies often lack aesthetic appeal and are not pleasing to view. Further, an individual may encounter difficulty in handling and/or carrying a beverage case after being packaged and adorned by a gift wrap assembly.

In addition, many gift wrap assemblies are available in an unfolded/unassembled form that may be utilized for configuring a usable form of the gift wrap assembly. However, it has been observed that an individual may encounter difficulties while configuring the usable form of the gift wrap assembly from the unfolded form due to structural complexities. Furthermore, adorning a beverage case in the traditional manner can be inconvenient to the gift giver to wrap and/or the receiver to unwrap, and also unwieldy to transport and/or carry while in wrapped form.

### SUMMARY

A gift wrap assembly for adorning a beverage case is provided. The gift wrap assembly includes a box for at least partially covering the beverage case. The box includes a top wall, four sidewalls, and a bottom opening. The gift wrap assembly further includes at least one gripping feature configured on at least one of the top wall and two oppositely configured sidewalls of the four sidewalls. Each gripping feature of the at least one gripping feature is conformed to substantially match a gripping feature in a corresponding wall of the beverage case.

In another aspect, an unfolded gift wrap assembly for adorning a beverage case is provided. The unfolded gift wrap assembly is capable of being folded into a box having a rectangular top wall, four sidewalls, and a bottom opening. The unfolded gift wrap assembly includes a rectangular top wall portion. The top wall portion is bounded by two short edges and two long edges. Further, the unfolded gift wrap assembly includes two narrow sidewall flaps. Each narrow sidewall flap is connected to a short edge of the top wall portion. Furthermore, the unfolded gift wrap assembly includes two wide sidewall flaps. Each wide sidewall flap is connected to a long edge of the top wall portion. Further, each wide sidewall flap is bounded by two sidewall support flaps. The unfolded gift wrap assembly also includes at least one gripping feature configured on at least one of the top wall portion, and the narrow sidewall flaps, the wide sidewall flaps, and the sidewall support flaps. Each gripping feature of the at least one gripping feature is conformed to substantially match a gripping feature in a corresponding wall of the beverage case. The top wall portion, and the narrow sidewall flaps, the wide sidewall flaps, and the sidewall support flaps are adapted to be folded with respect to each other so as to form the box capable of at least partially covering the beverage case.

In yet another aspect, the present disclosure provides an unfolded gift wrap assembly for adorning a beverage case. The unfolded gift wrap assembly is capable of being folded into a box having a square top wall, four sidewalls, and a bottom opening. The unfolded gift wrap assembly includes a square top wall portion. The top wall portion is bounded by four edges. The unfolded gift wrap assembly further includes four sidewall flaps. Each sidewall flap is connected to an edge of the top wall portion. Also, each sidewall flap of a pair of opposing sidewall flaps of the four sidewall flaps is being bounded by two sidewall support flaps. Furthermore, the unfolded gift wrap assembly includes at least one gripping feature configured on at least one of the top wall portion, the sidewall flaps, and the sidewall support flaps. Each gripping feature of the at least one gripping feature is conformed to substantially match a gripping feature in a corresponding wall of the beverage case. The top wall portion, the sidewall flaps, and the sidewall support flaps are capable of being folded with respect to each other to form the box capable of at least partially covering the beverage case.

In still another aspect, the present disclosure provides a method of making a gift wrap assembly for a beverage case. The method includes providing an unfolded gift wrap assembly. The unfolded gift wrap assembly includes a rectangular top wall portion. The top wall portion is bounded by two short edges and two long edges. Further, the unfolded gift wrap assembly includes two narrow sidewall flaps. Each narrow sidewall flap is connected to a short edge of the top wall portion. Furthermore, the unfolded gift wrap assembly includes two wide sidewall flaps. Each wide sidewall flap is connected to a long edge of the top wall portion. Further, each wide sidewall flap is bounded by two sidewall support flaps. The unfolded gift wrap assembly also includes at least one gripping feature configured on at least one of the top wall portion, and the narrow sidewall flaps, the wide sidewall flaps, and the sidewall support flaps. Each gripping feature of the at least one gripping feature is conformed to substantially match a gripping feature in a corresponding wall of the beverage case. The top wall portion, and the narrow sidewall flaps, the wide sidewall flaps, and the sidewall support flaps are adapted to be folded with respect to each other so as to form a box with a bottom opening. The box is capable of at least partially covering the beverage case.

The method further includes folding the sidewall support flaps upward into perpendicular relationship with the wide sidewall flaps. Furthermore, the method includes folding the wide sidewall flaps upward into perpendicular relationship with the top wall portion, while bringing the sidewall support flaps into overlapping relationship. Additionally, the method includes folding the narrow sidewall flaps upward into perpendicular relationship with the top wall portion, while bringing the narrow sidewall flaps into overlapping relationship with the sidewall support flaps. Moreover, the method includes fastening together the sidewall support flaps that are in overlapping relationship. In addition, the method includes fastening each narrow sidewall flap to corresponding sidewall support flaps that are in overlapping relationship.

These together with the other aspects of the present disclosure, along with the various features of novelty that characterize the present disclosure, are pointed out with particularity in the claims annexed hereto and form a part of the present disclosure. For a better understanding of the present disclosure, its operating advantages, and the specified objects attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a perspective view of a gift wrap assembly for adorning a beverage case, in accordance with an embodiment of the present disclosure;

FIG. 2 is a perspective view of the gift wrap assembly of FIG. 1 being utilized for adorning a beverage case, in accordance with an embodiment of the present disclosure;

FIG. 3 is a perspective view of the gift wrap assembly of FIG. 1 being utilized for adorning a beverage case, in accordance with another embodiment of the present disclosure;

FIG. 4 is a perspective view of the gift wrap assembly of FIG. 1 having an aesthetic appearance, in accordance with an embodiment of the present disclosure;

FIG. 5 is a perspective view of a gift wrap assembly being utilized for adorning a beverage case, in accordance with another embodiment of the present disclosure;

FIG. 6 is a top view of an unfolded gift wrap assembly, in accordance with an embodiment of the present disclosure;

FIG. 7 is a top view of an unfolded gift wrap assembly, in accordance with another embodiment of the present disclosure;

FIGS. 8 to 11 depict stages of folding of the unfolded gift wrap assembly of FIG. 6 to obtain a usable form of the gift wrap assembly, in accordance with an embodiment of the present disclosure; and

FIG. 12 illustrates a flow chart of a method for making the gift wrap assembly of FIG. 1, in accordance with an embodiment of the present disclosure.

Like reference numerals refer to like parts throughout the description of several views of the drawings.

### DETAILED DESCRIPTION OF THE DISCLOSURE

The exemplary embodiments described herein in detail for illustrative purposes are subject to many variations in structure and design. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the terms, “a” and “an” herein do not denote a limitation of quantity, but rather denote the presence of at least one of the referenced item.

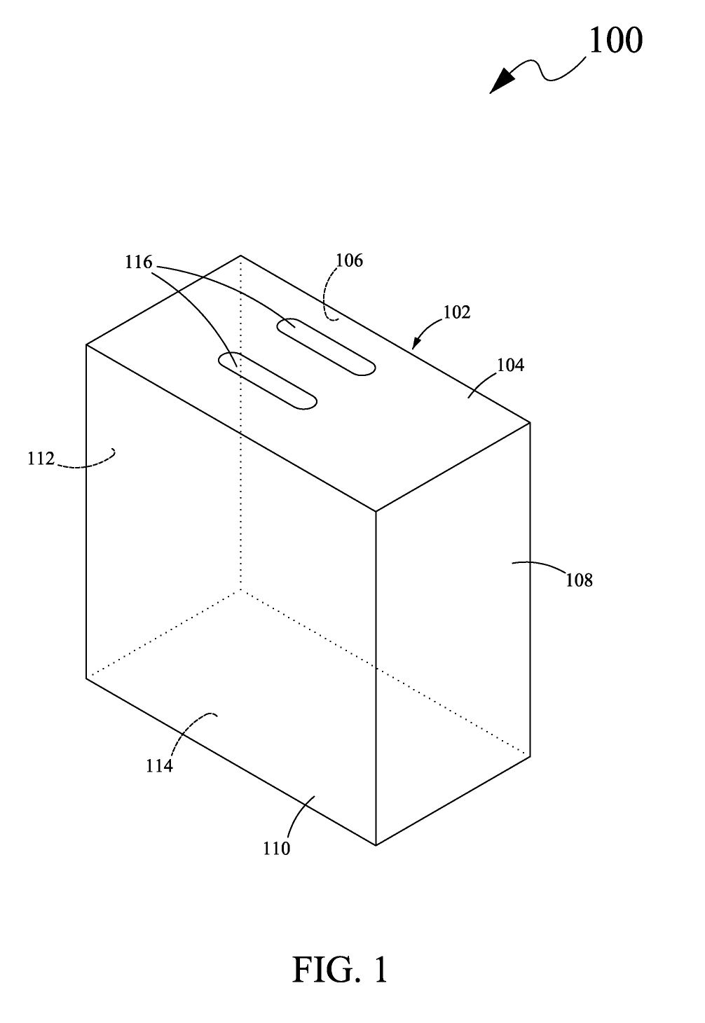

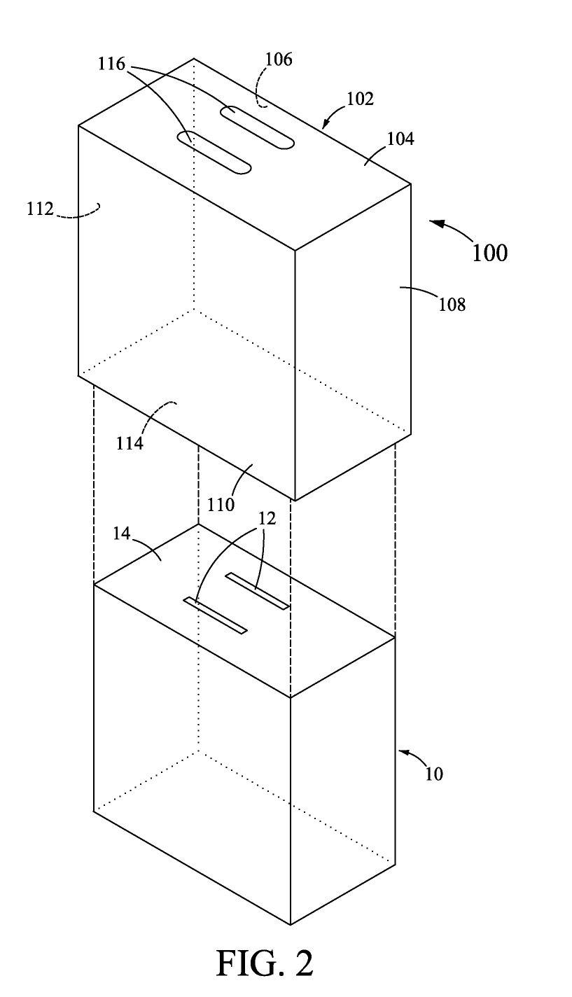

In one aspect, the present disclosure provides a gift wrap assembly for adorning a beverage case that may hold either bottles or cans of a beverage, such as beer. The gift wrap assembly of the present disclosure is explained in conjunction with FIGS. 1 and 2.

Referring to FIGS. 1 and 2, a gift wrap assembly 100 is disclosed. The gift wrap assembly 100 includes a box 102 for at least partially covering a beverage case 10. The beverage case 10 may be a conventional case for holding six to twenty four beverage cans or beverage bottles. However, it will be evident that the beverage case 10 may be a case for holding any other number of beverage cans or beverage bottles.

The box 102 includes a top wall 104. The box 102 also includes four sidewalls 106, 108, 110, 112. Further, the box 102 includes a bottom opening 114 configured by the four sidewalls 106, 108, 110, 112, and opposite to the top wall 104. The gift wrap assembly 100 may be capable of being received on the beverage case 10 through the bottom opening 114, as shown in FIG. 2.

Furthermore, the box 102 includes at least one gripping feature, such as a pair of slots 116, configured on the top wall 104. The slots 116 are conformed to substantially match a gripping feature, such as a pair of slots 12, on a top wall 14 of the beverage case 10. More specifically, the slots 116 are capable of covering the pair of slots 12.

In use, the beverage case 10 may be received into the gift wrap assembly 100 through the bottom opening 114 (as shown in FIG. 2). In the received position, the slots 116 are capable of covering the slots 12. A person for holding and carrying the beverage case 10 adorned with the gift wrap assembly 100 may hold the beverage case 10 by gripping the slots 116.

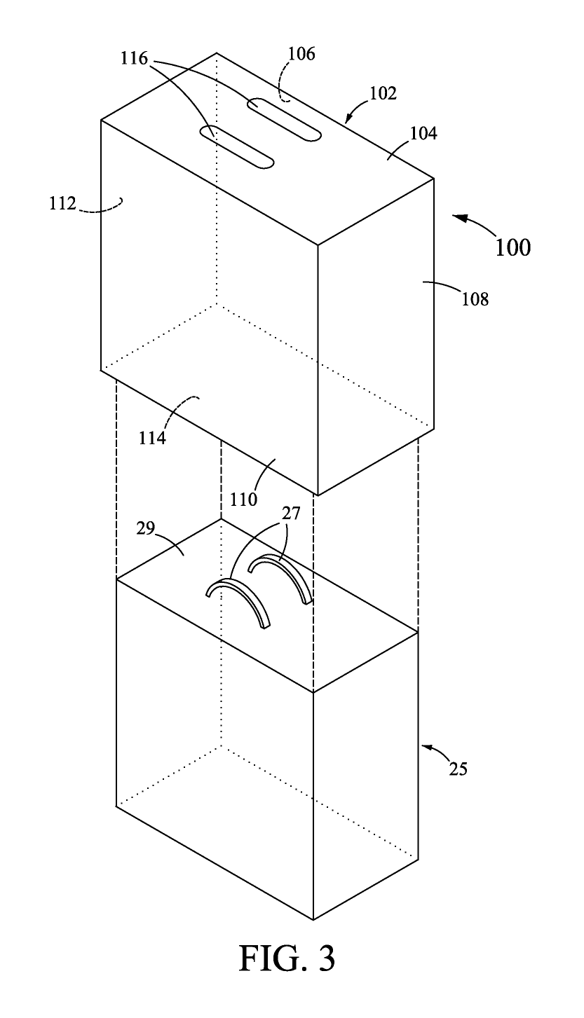

In one embodiment of the present disclosure, the slots 116 may also be conformed to substantially match another gripping feature that may be provided in the beverage case 10. Such embodiment is as shown in FIG. 3. More specifically, as best shown in FIG. 3, a beverage case 25 includes a pair of handles 27 (as the gripping feature) on a top wall 29 of the beverage case 25. The slots 116 may be adapted to conform to the handles 27 of the beverage case 25. Even more specifically, the slots 116 may be adapted to receive the handles 27 of the beverage case 25.

In use, the beverage case 25 may be received into the gift wrap assembly 100 through the bottom opening 114. In the received position, the slots 116 are capable of receiving the handles 27. The handles 27 may be held by a person for holding and carrying the beverage case 25 adorned with the gift wrap assembly 100.

The box 102 may be composed of a cardboard material. Alternatively, the box 102 may be composed of a durable paper material, such as a paperboard material. Further, the box 102 may be configured to have a rectangular or a square shape. However, the box 102 may be configured to have any other shape and dimension corresponding to the shape and the dimension of a beverage case that needs to be covered with the gift wrap assembly 100.

In one form, the gift wrap assembly 100 may have a length of about 15¾ inches (″), a height of about 10¾″, and a width of about 5″. Further, the gripping feature 116 may have a length of about 3½″, and a width of about 1″. Furthermore, the gripping feature 116 may have rounded ends and may be separated from another gripping feature by a distance of about 1½″. However, it may be evident that the gripping feature 116 may be configured to have any other size and shape.

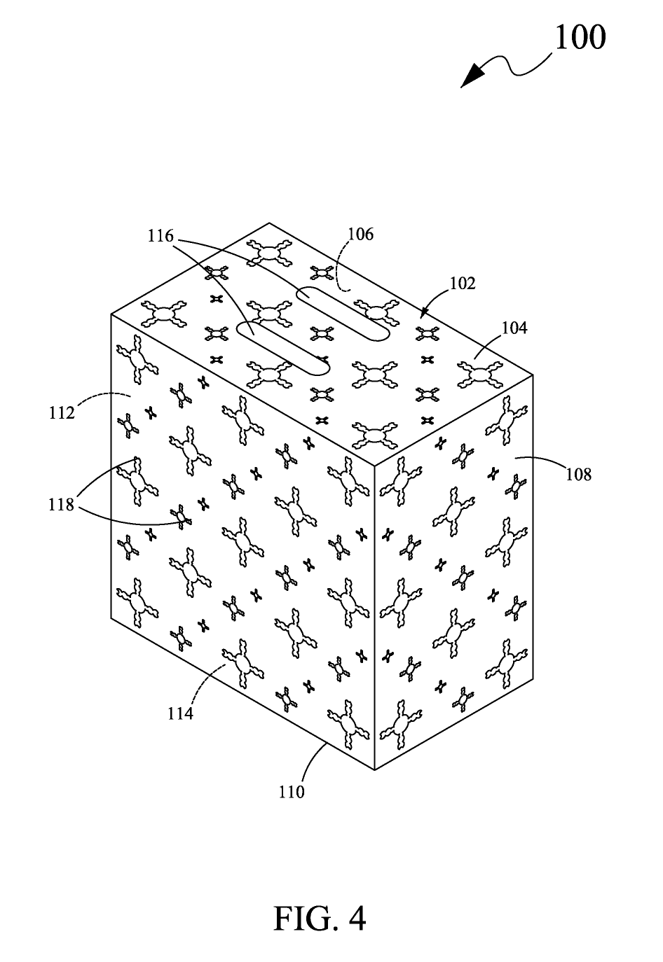

As shown in FIG. 4, the gift wrap assembly 100 may further include one or more designs, such as one or more designs 118, thereon for providing an aesthetic appearance to the gift wrap assembly 100. Accordingly, the gift wrap assembly 100 is appealing to view. Additionally, the gift wrap assembly 100 may include one or more labels (not shown) thereon for identifying the contents of the beverage case 10.

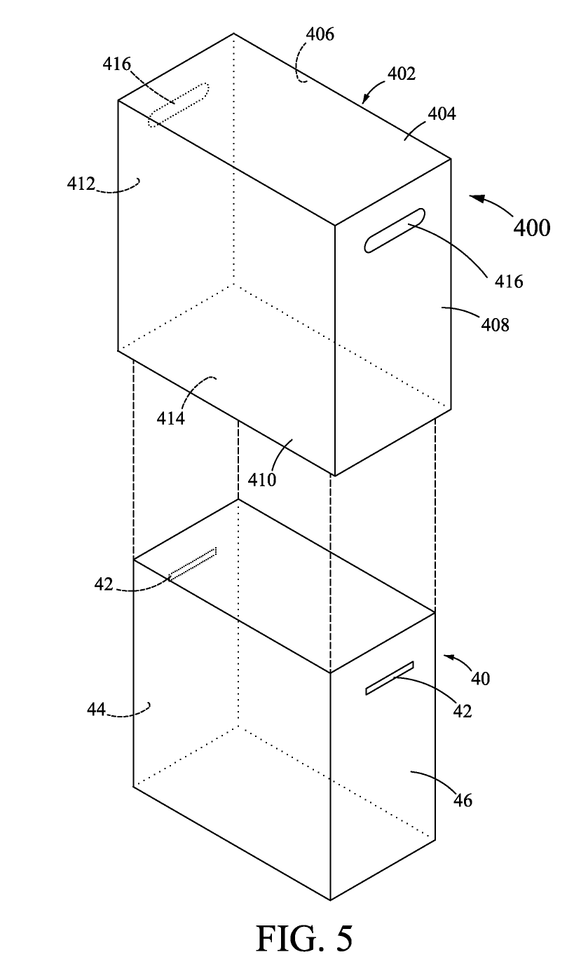

FIG. 5 is a perspective view of a gift wrap assembly 400 for adorning a beverage case, such as a beverage case 40, in accordance with another embodiment of the present disclosure. The gift wrap assembly 400 is similar to the gift wrap assembly 100, and includes a box 402 for at least partially covering the beverage case 40. The box 402 includes a top wall 404; four sidewalls 406, 408, 410 and 412; a bottom opening 414 configured by the four sidewalls 406, 408, 410 and 412; and at least one gripping feature. Herein, the gripping feature is a pair of slots 416, with one slot 416 each configured on two oppositely configured sidewalls 408, 412. Such an alternate form facilitates the gift wrap assembly 400 to cover beverage cases, such as, a beverage case 40. The beverage case 40 has a gripping feature in the form of a pair of slots 42, with one slot 42 each configured on two oppositely configured sidewalls 44, 46 of the beverage case 40. The slots 416 are capable of receiving the corresponding slots 42.

In use, the beverage case 40 may be received into the gift wrap assembly 400 through the bottom opening 414 (as shown in FIG. 5). In the received position, the slots 416 are capable of receiving the slots 42.

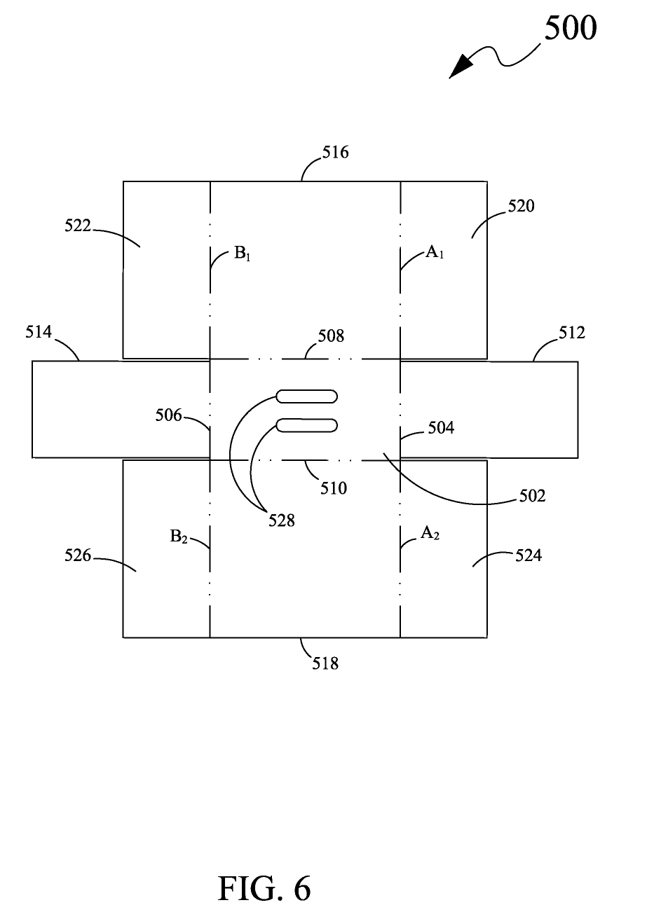

FIG. 6 shows an unfolded gift wrap assembly 500, according to an embodiment of the present disclosure. The unfolded gift wrap assembly 500 is an unassembled form that may be folded/assembled to form a gift wrap assembly, such as the gift wrap assembly 100 as shown in FIG. 1. Specifically, the unfolded gift wrap assembly 500 is capable of being folded into a box, such as the box 102, having a rectangular top wall, four sidewalls, and a bottom opening.

As shown in FIG. 6, the unfolded gift wrap assembly 500 includes a rectangular top wall portion 502. The top wall portion 502 is bounded by two short edges 504, 506 and two long edges 508, 510. The unfolded gift wrap assembly 500 further includes two narrow sidewall flaps 512, 514. The narrow sidewall flap 512 is connected to the short edge 504 of the top wall portion 502. Similarly, the narrow sidewall flap 514 is connected to the short edge 506 of the top wall portion 502.

Furthermore, the unfolded gift wrap assembly 500 includes two wide sidewall flaps 516, 518. The wide sidewall flap 516 is connected to the long edge 508 of the top wall portion 502. Similarly, the wide sidewall flap 518 is connected to the long edge 510 of the top wall portion 502. Each wide sidewall flap of the wide sidewall flaps 516, 518 is being bounded by two sidewall support flaps. Specifically, the wide sidewall flap 516 is being bounded by two sidewall support flaps 520, 522. Similarly, the wide sidewall flap 518 is being bounded by two sidewall support flaps 524, 526.

The top wall portion 502 may be composed of a cardboard material. Alternately, the top wall portion 502 may be composed of a durable paper material. Each of the narrow sidewall flaps 512, 514; the wide sidewall flaps 516, 518; and the sidewall support flaps 520, 522, 524, 526 may be composed of a cardboard material. Alternately, the each of the narrow sidewall flaps 512, 514; the wide sidewall flaps 516, 518; and the sidewall support flaps 520, 522, 524, 526 may be composed of a durable paper material.

In addition, the unfolded gift wrap assembly 500 includes at least one gripping feature, such as a pair of slots 528, configured on the top wall portion 502. The slots 528 are conformed to substantially match a gripping feature in a corresponding wall of the beverage case (not shown), such as the beverage case 10. More specifically, the slots 528 are capable of receiving the pair of slots 12 of the beverage case 10. In another form, the gripping feature (i.e., a pair of slots) may be configured to adorn a beverage case, such as, the beverage case 40. More specifically, the slots are configured on at least one of the sidewall flaps 512, 514, 516, 518, and the sidewall support flaps 520, 522, 524, 526 to receive corresponding slots 42 of the beverage case 40.

The top wall portion 502; the narrow sidewall flaps 512, 514; the wide sidewall flaps 516, 518; and the sidewall support flaps 520, 522, 524, 526 are adapted to be folded with respect to each other so as to form the box, similar to the box 102 with the bottom opening, similar to the bottom opening 114, as shown in FIG. 1. The box so formed is capable of at least partially covering the beverage case 10. As shown in FIG. 6, the unfolded gift wrap assembly 500 is being folded into the box where the top wall portion 502 forms the top wall of the box, and the narrow sidewall flaps 512, 514 and the wide sidewall flaps 516, 518 form the four sidewalls of the box.

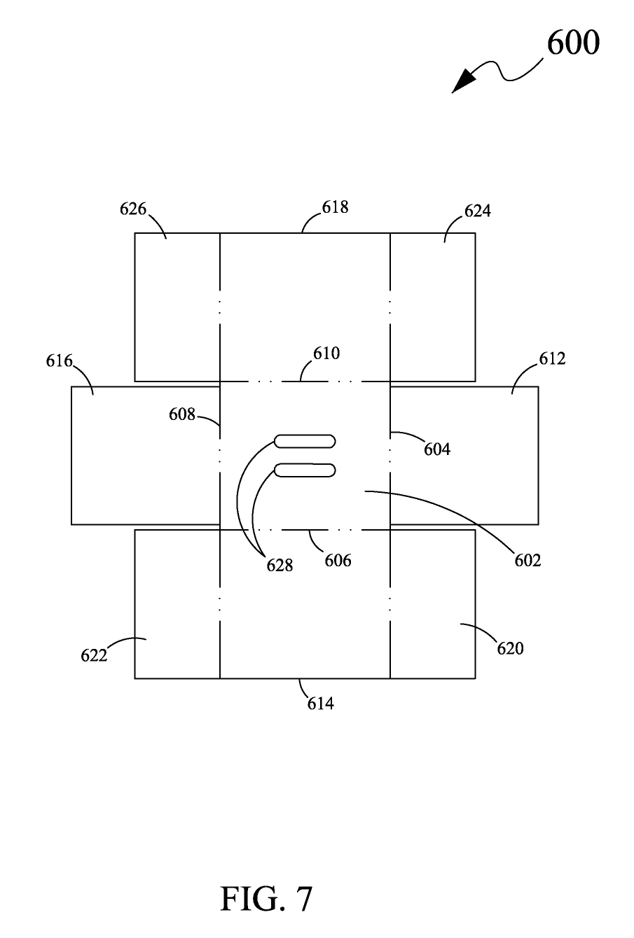

FIG. 7 shows a top view of an unfolded gift wrap assembly 600, in accordance with an alternate embodiment of the present disclosure. The unfolded gift wrap assembly 600 is capable of being folded into a box having a square top wall, four sidewalls, and a bottom opening.

The unfolded gift wrap assembly 600 includes a square top wall portion 602. The top wall portion 602 is bounded by four edges 604, 606, 608, 610. The unfolded gift wrap assembly 600 further includes four sidewall flaps 612, 614, 616, 618 being connected to respective edges 604, 606, 608, 610. Each of opposing sidewall flaps 614, 618 is bounded by two sidewall support flaps. Specifically, the sidewall flap 614 is bound by sidewall support flaps 620, 622. Similarly, the sidewall flap 618 is bound by sidewall support flaps 624, 626.

The unfolded gift wrap assembly 600 also includes at least one gripping feature, such as a pair of slots 628, configured on the top wall portion 602. The slots 628 are conformed to substantially match a gripping feature in a corresponding wall of the beverage case, such as the beverage case 10. More specifically, the slots 628 are capable of receiving the pair of slots 12 of the beverage case 10. In another form, the gripping feature (i.e., a pair of slots) may be configured to adorn a beverage case, such as, the beverage case 40. More specifically, the slots are configured on at least one of the sidewall flaps 612, 614, 616, 618, and the sidewall support flaps 620, 622, 624, 626 to receive corresponding slots 42 of the beverage case 40.

The top wall portion 602, the sidewall flaps 612, 614, 616, 618, and the sidewall support flaps 620, 622, 624, 626 are capable of being folded with respect to each other to form the box with the bottom opening. The box is capable of at least partially covering the beverage case, which is square in shape. As shown in FIG. 7, the unfolded gift wrap assembly 600 is being folded into the box where the top wall portion 602 forms the top wall of the box, and the sidewall flaps 612, 614, 616, 618 form the four sidewalls of the box.

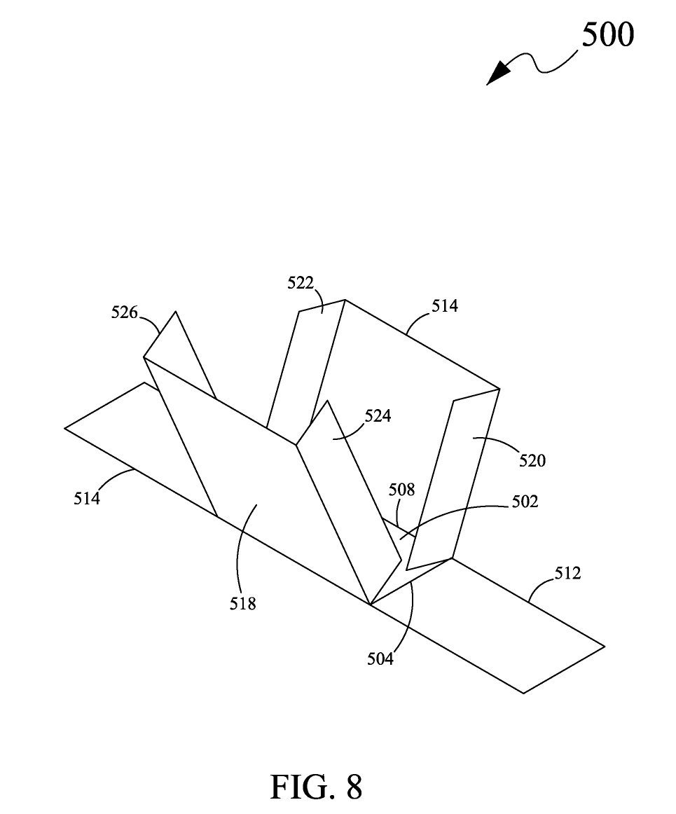

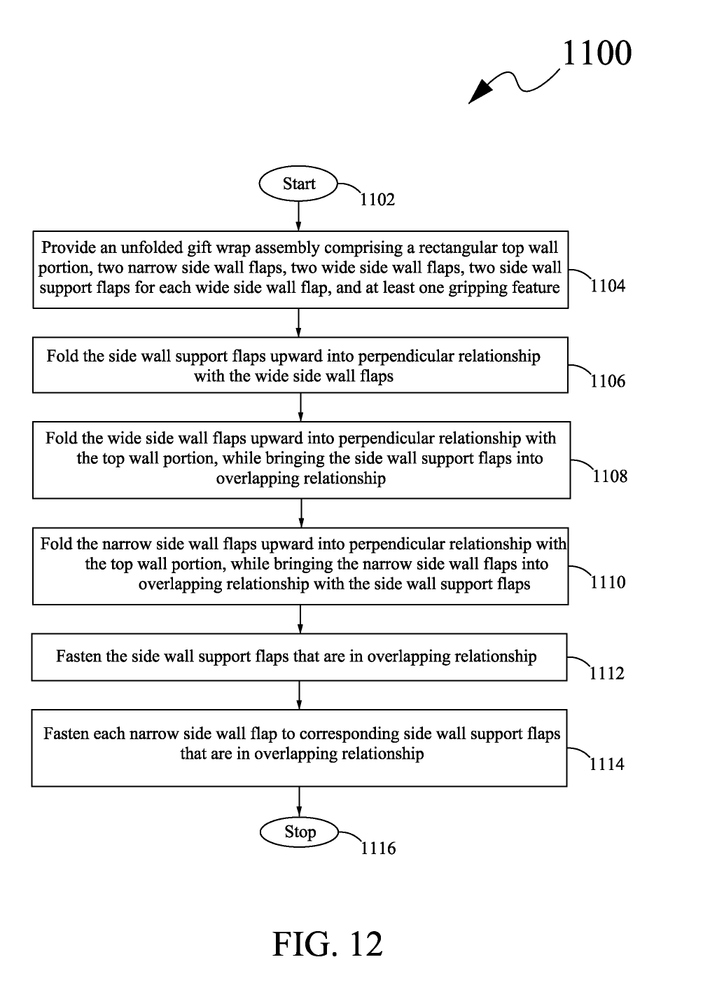

Referring to FIGS. 8-11, the stages of folding of the unfolded gift wrap assembly 500 of FIG. 6 to obtain the gift wrap assembly, such as the gift wrap assembly 100 of FIG. 1, are shown. Further, FIGS. 8-11 will be explained in conjunction with FIG. 12, which illustrates a flow chart of a method of making the gift wrap assembly from the unfolded gift wrap assembly 500 of FIG. 6. Further, reference would be made to FIG. 6, and FIGS. 8-11 for describing the method of making the gift wrap assembly 100 of FIG. 1. However, it may be evident that the method as described herein below may be used to obtain a square-shaped gift wrap assembly from the unfolded gift wrap assembly 600 of FIG. 7.

Referring to FIG. 12, a method 1100 for making the gift wrap assembly 100 is disclosed. The method 1100 starts at 1102. At 1104, the unfolded gift wrap assembly 500 is provided. At 1106, the sidewall support flaps 520, 522 are folded upward into perpendicular relationship with the wide sidewall flap 516 along lines A₁ and B₁, respectively (as shown in FIG. 8). Further, the sidewall support flaps 524, 526 are folded upward into perpendicular relationship with the wide sidewall flap 518 along lines A₂ and B₂, respectively (as shown in FIG. 8).

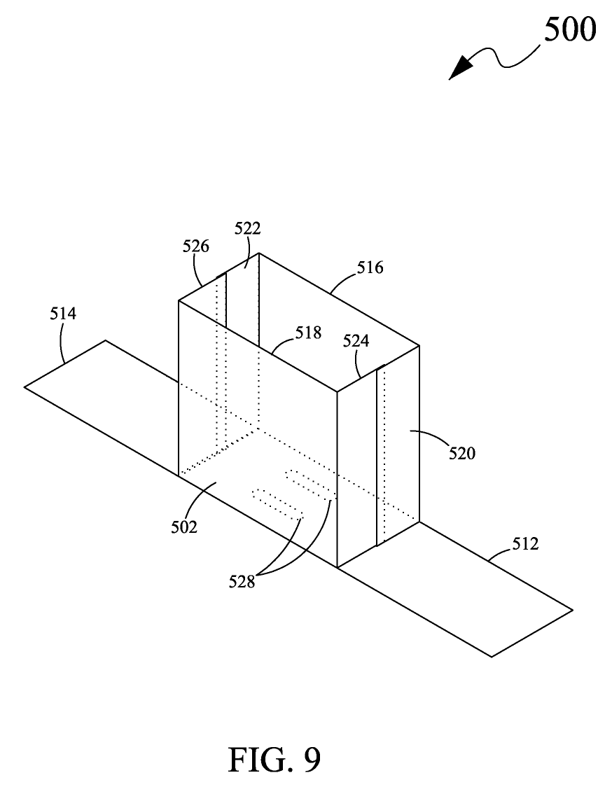

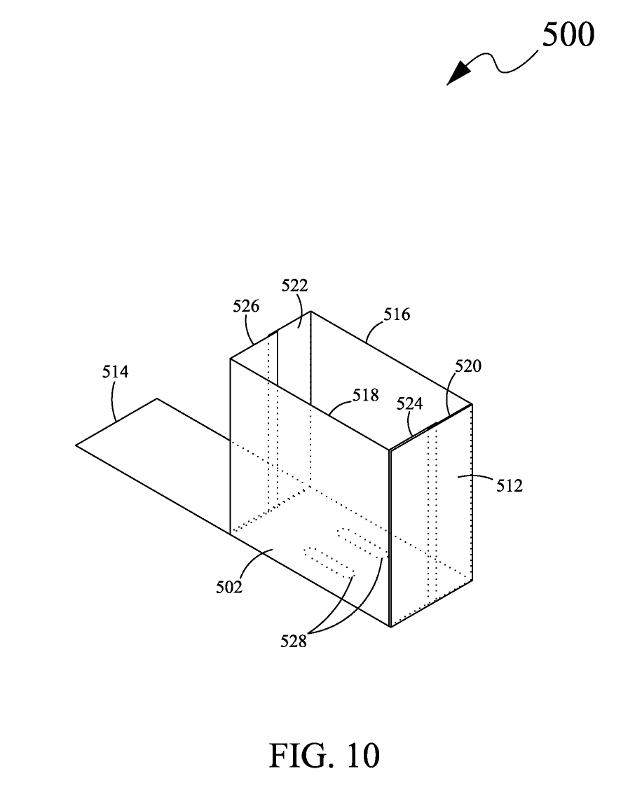

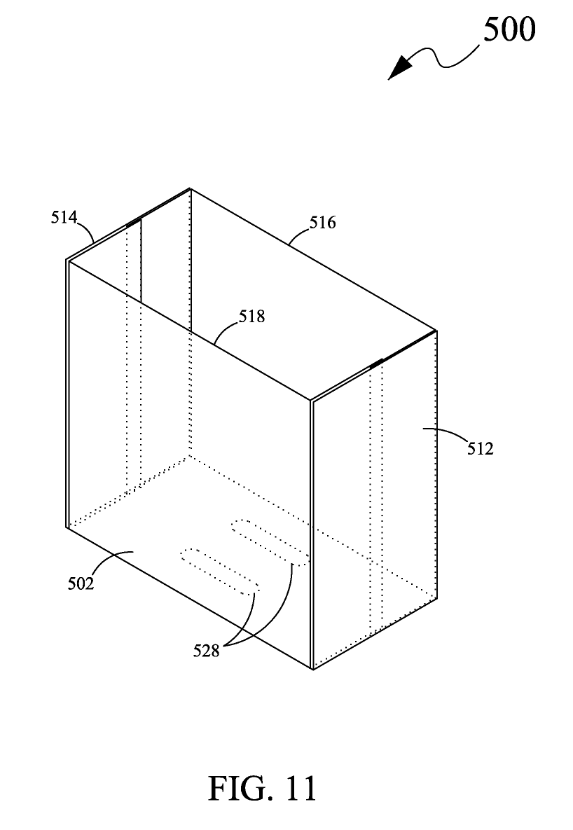

At 1108, the wide sidewall flaps 516, 518 are folded upward into perpendicular relationship with the top wall portion 502 along the respective long edges 508 and 510 (as shown in FIG. 8), while bringing the sidewall support flaps 520 and 524 into an overlapping relationship and the sidewall support flaps 522 and 526 into an overlapping relationship (as shown in FIG. 9). At 1110, the narrow sidewall flaps 512, 514 are folded upward into perpendicular relationship with the top wall portion 502 along the respective short edges 504 and 506, while bringing the narrow sidewall flaps 512, 514 into an overlapping relationship with the respective sidewall support flaps 520, 524 and 522, 526 (as shown in FIGS. 10 and 11).

At 1112, the sidewall support flaps 520, 524 and 522, 526 are fastened in the respective overlapping relationship. In one form, the sidewall support flaps 520, 524 and 522, 526 may be fastened with the help of fastener means, such as stapler pins. However, it will be evident that any other fastening means, such as a clip pin, an adhesive, a sticker, a decal, a tape, and the like, may be used for fastening the sidewall support flaps 520, 524 and 522, 526. At 1114, the narrow sidewall flap 512 is fastened to the sidewall support flaps 520, 524, and the narrow sidewall flap 514 is fastened to the sidewall support flaps 522, 526. In one form, the narrow sidewall flap 512 is fastened to the sidewall support flaps 520, 524, and the narrow sidewall flap 514 is fastened to the sidewall support flaps 522, 526 with the help of fastener means, such as stapler pins. However, it will be evident that any other fastening means, such as a clip pin, an adhesive, a sticker, a decal, a tape, and the like, may be used for fastening the narrow sidewall flap 512 and the narrow sidewall flap 514. The method stops at 1116.

The present disclosure provides a gift wrap assembly, such as the gift wrap assemblies 100 and 400. The gift wrap assembly serves as a decorative sleeve for covering and adorning a beverage case, such as the beverage cases 10, 40. Further, the gift wrap assembly includes at least one gripping feature, to conform to match a gripping feature in corresponding wall(s) of the beverage case 10, 40. Such engagement of gripping features (as described in conjunction with FIGS. 1 to 4), provides an easy handling of the beverage case after being packaged and adorned by the gift wrap assembly. Also, the present disclosure provides an easy-to-use method, such as the method 1100, for making a gift wrap assembly for adorning a beverage case.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A gift wrap assembly for adorning a beverage case, the gift wrap assembly comprising:
a box for at least partially covering the beverage case, the box comprising,
a top wall,
four sidewalls, and
a bottom opening; and
at least one gripping feature configured on at least one of the top wall and two oppositely configured sidewalls of the four sidewalls, each gripping feature of the at least one gripping feature being conformed to substantially match a gripping feature in a corresponding wall of the beverage case.

2. The gift wrap assembly of claim 1, wherein the at least one gripping feature is one or more slots capable of receiving the gripping feature in the corresponding wall of the beverage case.

3. The gift wrap assembly of claim 1, wherein the box is composed of a cardboard material.

4. The gift wrap assembly of claim 1, wherein the box is composed of a durable paper material.

5. An unfolded gift wrap assembly for adorning a beverage case, the unfolded gift wrap assembly being foldable into a box having a rectangular top wall, four sidewalls, and a bottom opening, the unfolded gift wrap assembly comprising:
a rectangular top wall portion, the top wall portion being bounded by two short edges and two long edges;
two narrow sidewall flaps, each narrow sidewall flap being connected to a short edge of the top wall portion;
two wide sidewall flaps, each wide sidewall flap being connected to a long edge of the top wall portion, each wide sidewall flap being bounded by two sidewall support flaps; and
at least one gripping feature configured on at least one of the top wall portion, the narrow sidewall flaps, the wide sidewall flaps and the sidewall support flaps, each gripping feature of the at least one gripping feature being conformed to substantially match a gripping feature in a corresponding wall of the beverage case,
wherein the top wall portion, and the narrow sidewall flaps, the wide sidewall flaps, and the sidewall support flaps are adapted to be folded with respect to each other so as to form the box capable of at least partially covering the beverage case.

6. The unfolded gift wrap assembly of claim 5, wherein the each gripping feature of the at least one gripping feature is one or more slots capable of receiving the gripping feature in a corresponding wall of the beverage case.

7. The unfolded gift wrap assembly of claim 5, wherein each of the top wall portion, the narrow sidewall flaps, the wide sidewall flaps, and the sidewall support flaps is composed of a cardboard material.

8. The unfolded gift wrap assembly of claim 5, wherein each of the top wall portion, the narrow sidewall flaps, the wide sidewall flaps, and the sidewall support flaps is composed of a durable paper material.

9. An unfolded gift wrap assembly for adorning a beverage case, the unfolded gift wrap assembly being foldable into a box having a square top wall, four sidewalls, and a bottom opening, the unfolded gift wrap assembly comprising:
a square top wall portion, the top wall portion being bounded by four edges;
four sidewall flaps, each sidewall flap being connected to an edge of the top wall portion, each sidewall flap of a pair of opposing sidewall flaps of the four sidewall flaps being bounded by two sidewall support flaps; and
at least one gripping feature configured on at least one of the top wall portion, the sidewall flaps, and the sidewall support flaps, each gripping feature of the at least one gripping feature being conformed to substantially match a gripping feature in a corresponding wall of the beverage case,
wherein the top wall portion, the sidewall flaps, and the sidewall support flaps are capable of being folded with respect to each other to form the box capable of at least partially covering the beverage case.

10. The unfolded gift wrap assembly of claim 9, wherein the at least one gripping feature is one or more slots capable of receiving the gripping feature in a corresponding wall of the beverage case.

11. The unfolded gift wrap assembly of claim 9, wherein each of the top wall portion, the sidewall flaps, and the sidewall support flaps is composed of a cardboard material.

12. The unfolded gift wrap assembly of claim 9, wherein each of the top wall portion, the sidewall flaps, and the sidewall support flaps is composed of a durable paper material.

13. A method of making a gift wrap assembly for a beverage case, the method comprising:
providing an unfolded gift wrap assembly, the unfolded gift wrap assembly being foldable into a box having a rectangular top wall, four sidewalls, and a bottom opening, the unfolded gift wrap assembly comprising:
a rectangular top wall portion, the top wall portion being bounded by two short edges and two long edges,
two narrow sidewall flaps, each narrow sidewall flap being connected to a short edge of the top wall portion,
two wide sidewall flaps, each wide sidewall flap being connected to a long edge of the top wall portion, each wide sidewall flap being bounded by two sidewall support flaps, and
at least one gripping feature configured on at least one of the top wall portion, and the narrow sidewall flaps, the wide sidewall flaps, and the sidewall support flaps, each gripping feature of the at least one gripping feature being conformed to substantially match a gripping feature in a corresponding wall of the beverage case,
wherein the top wall portion, the narrow sidewall flaps, the wide sidewall flaps, and the sidewall support flaps are capable of being folded with respect to each other to form a box with a bottom opening, the box capable of at least partially covering the beverage case;
folding the sidewall support flaps upward into perpendicular relationship with the wide sidewall flaps;
folding the wide sidewall flaps upward into perpendicular relationship with the top wall portion, while bringing the sidewall support flaps into overlapping relationship;
folding the narrow sidewall flaps upward into perpendicular relationship with the top wall portion, while bringing the narrow sidewall flaps into overlapping relationship with the sidewall support flaps;
fastening together the sidewall support flaps that are in overlapping relationship; and
fastening each narrow sidewall flap to corresponding sidewall support flaps that are in overlapping relationship.

14. The method of claim 13, wherein the at least one gripping feature is one or more slots capable of receiving the gripping feature in a corresponding wall of the beverage case.

15. The method of claim 13, wherein each of the top wall portion, the narrow sidewall flaps, the wide sidewall flaps, and the sidewall support flaps is composed of a cardboard material.

16. The method of claim 13, wherein each of the top wall portion, the narrow sidewall flaps, the wide sidewall flaps, and the sidewall support flaps is composed of a durable paper material.
